(19) United States
(12) Patent Application Publication
(10) Pub. No.: US 2016/0084756 A1
(43) Pub. Date: Mar. 24, 2016

(54) Thermal Maturity Indicator

(71) Applicant: SCHLUMBERGER CANADA LIMITED, Calgary (CA)

(72) Inventors: Michael M. Herron, Cambridge, MA (US); Susan Herron, Cambridge, MA (US); Alyssa Charsky, Boston, MA (US)

(21) Appl. No.: 14/787,791

(22) PCT Filed: May 2, 2014
(86) PCT No.: PCT/US2014/036573

§ 371 Date: Oct. 29, 2015

Related U.S. Application Data
(60) Provisional application No. 61/818,675, filed on May 2, 2013.
(60) Provisional application No. 61/901,845, filed on Nov. 8, 2013.

(51) Int. Cl. G01N 21/3563; G01N 21/47

(52) U.S. Cl. CPC G01N 21/3563; G01N 21/4738; G01N 2021/3595

(57) ABSTRACT

Systems and methods are described for analyzing hydrocarbon bearing earth samples to determine information indicating the maturation, or changes in composition of kerogen from original deposition over geologic time as the kerogen is subjected to heat and pressure. A DRIFTS spectrometry signal is corrected and normalized and then plotted against TOC data to obtain an index indicating thermal maturity.

### CROSS-REFERENCE TO RELATED APPLICATIONS

This patent application claims the benefit of U.S. Prov. Ser. No. 61/818,675, filed May 2, 2013 and U.S. Prov. Ser. No. 61/901,845, filed Nov. 8, 2013, both of which are incorporated by reference herein.

### FIELD

The subject disclosure relates generally to analyzing earth samples. More particularly, the subject disclosure relates to analyzing hydrocarbon bearing earth samples to determine information indicating the maturation, or changes in composition of kerogen from original deposition over geologic time as the kerogen is subjected to heat and pressure.

### BACKGROUND

Kerogen is composed of organic matter, which has been transformed due to a maturation process. Hydrocarbon containing formations having kerogen include, but are not limited to, coal containing formations and oil shale containing formations. The maturation process may include two stages: a biochemical stage and a thermal stage. The biochemical stage involves degradation of organic material by both aerobic and anaerobic mechanisms. The thermal stage involves conversion of organic matter due to temperature changes and significant pressures. During maturation, oil and gas may be produced, as organic matter of kerogen is transformed.

Tissot, R. P. & Welte, D. H., 1984. Petroleum Formation and Occurrence. 2nd Ed. Springer Berlin Heidelberg New York, (hereinafter “Tissot ad Welte”) p. 699 summarized the evolution of the major categories of kerogen during burial and exposure to increasing temperature and pressure. One of the primary changes in the kerogen is the reduction in the hydrogen to carbon ratio. The hydrogen index decreases as hydrocarbons are generated, and the remaining kerogen is depleted in hydrogen with respect to carbon. Infrared spectroscopy, particularly FT-IR and DRIFTS, responds to the presence of aliphatic C—H bonds in the 2900-3100 cm⁻¹ region. Thus, in analyses of kerogens subjected to artificial and natural maturation, Tissot and Welte (p. 155) and Lis, G. P., Mastalerz, M. Schimmelmann, A., Lewan, M. D., and Stankiewicz, B. A., 2005, “FTIR absorption indices for thermal maturity in comparison with vitrinite reflectance R0 in type-II kerogens from Devonian black shales,” Organic Geochemistry, 36, 1533-1552. (hereinafter “Lis et al.”) showed a number of changes in FT-IR signature that could be linked at least qualitatively to maturity. One of the links was the ratio of aromatic hydrocarbons in the 3000-3100 cm⁻¹ range to aliphatic hydrocarbons in the 2800-3000 cm⁻¹ range.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a method of analyzing earth samples is described. The method includes: analyzing a first sample using diffuse reflectance infrared fourier transform spectroscopy (DRIFTS) to collect one or more spectra of infrared energy reflected from the first earth sample and to create a first spectral dataset therefrom; analyzing the first spectral dataset to generate a first processed DRIFTS signal; receiving total organic matter data representing a concentration of organic material in the first earth sample; and determining a thermal maturity value indicative of a thermal maturation history of the earth samples. The thermal maturity value is based on the first processed DRIFTS signal and the total organic matter data. According to some embodiments, the analyzing includes removing influence of inorganic materials from the first processed DRIFTS signal and normalizing the first processed DRIFTS signal to generate a first normalized organic infrared signal. The thermal maturity value can be based on a ratio of the first total organic matter data and the first normalized organic infrared signal. According to some embodiments, the processed DRIFTS signal is based on reflected spectra of the infrared energy in a region having a range of between 2800-3100 cm-1, and the removal of influence of inorganic materials is based on using one or more spectra outside of the region to identify contributions due to the inorganic materials.

According to some embodiments, the method can further include repeating the analyzing for further earth samples to create further spectral datasets and the thermal maturity value can be based on the further spectral datasets. According to some embodiments, the total organic matter data indicates total organic carbon and is based on laboratory measurements. According to some other embodiments, the total organic matter data is based on one or more downhole measurements. According to some embodiments, the earth samples are from a shale gas or shale oil reservoir. The method can be performed at a wellsite, for example during a drilling process where drill cuttings are gathered for use as the earth samples.

According to some embodiments, a system for analyzing earth samples is described. The system includes: a DRIFTS system configured to irradiate earth samples with infrared energy and collect spectra of the infrared energy reflected from the earth samples; and a processing system configured to receive data representing spectra collected by the DRIFTS system and data representing total organic matter of the earth samples, and to determine a thermal maturity value indicative of a thermal maturation history of the earth samples. The thermal maturity value is based on the received data representing spectra and the received data representing total organic matter. According to some embodiments a downhole gamma-ray measurement tool can be used to make measurements from which the total organic matter can be determined.

According to some embodiments, a method of analyzing an earth sample is described that includes: analyzing a first sample using diffuse reflectance infrared fourier transform spectroscopy (DRIFTS) to collect one or more spectra of infrared energy reflected from the first earth sample and to create a spectral dataset therefrom; analyzing the spectral dataset thereby generating a processed DRIFTS signal; receiving thermal maturity data indicative of a thermal maturation history of the earth sample; and determining a TOC value representing a concentration of organic material in the earth sample based on a relationship between the processed DRIFTS signal intensity and the thermal maturity data. According to some embodiments, the thermal maturity data is based on vitrinite reflectance measurements. According to some other embodiments, the thermal maturity data is based on Tₘₐₓ measurements.

According to some embodiments, a system for analyzing earth samples is described that includes: a DRIFTS system configured to irradiate an earth sample with infrared energy and collect spectra of the infrared energy reflected from the earth sample; and a processing system configured to receive spectra data representing spectra collected by the DRIFTS system and thermal maturity data indicative of a thermal maturation history of the earth sample, and to determine a TOC value representing a concentration of organic material in the earth sample based on a relationship between the spectra data and the thermal maturity data.

Further features and advantages of the subject disclosure will become more readily apparent from the following detailed description, when taken in conjunction with the accompanying drawings.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 is a graph illustrating the relationship between the processed DRIFTS signal and total organic carbon for a set of earth samples, according to some embodiments;

FIG. 2 is a graph comparing measured maturity versus DRIFTS-determined thermal maturity for a number of sample sets, according to some embodiments;

FIGS. 3-6 are graphs illustrating the relationship between the kerogen concentration from the DRIFTS signal and total organic carbon for different sets of earth samples, according to some embodiments;

FIG. 7 shows two graphs illustrating aspects of borehole log derived total organic carbon and DRIFTS data, according to some embodiments;

FIG. 8 is a flow chart illustrating aspects of determining thermal maturity of a rock formation based on DRIFTS analysis, according to some embodiments;

FIG. 9 is a flow chart illustrating aspects of determining TOC of a rock formation based on DRIFTS analysis, according to some embodiments;

FIG. 10 is a diagram showing a wireline tool being deployed in a wellbore along with a DRIFTS spectrometer and processing unit for determining thermal maturity, according to some embodiments; and

FIG. 11 illustrates a wellsite system in which a thermal maturity value can be determined from DRIFTS analysis of drill cuttings while drilling, according to some embodiments.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified, unless otherwise indicated in context. Also, in the summary of the disclosure and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to a few specific, it is to be understood that inventors appreciate and understand that any and all data points within the range are to be considered to have been specified, and that inventors possessed knowledge of the entire range and all points within the range.

In unconventional reservoirs, it is desirable to include reservoir quality assessments based on kerogen content and kerogen thermal maturity. However, analysis of TOC by industry standard techniques such as LECO and/or thermal pyrolysis procedures such as RockEval, which gives the temperature of maximum organic emission that is a proxy for thermal maturity, are also time consuming. Additionally, the measurement of mineralogy, TOC, and thermal maturity are often performed as separate analyses. According to some embodiments, a rapid technique is described that is capable of providing mineralogy, especially clay mineralogy, plus TOC and information on kerogen thermal maturity. Diffuse Reflectance Infrared Fourier Transform Spectroscopy (DRIFTS) can quickly measure mineralogy and organic matter in sediments with minor sample preparation. According to some embodiments, DRIFTS analysis including sample preparation can be preformed in less than 20 minutes for any mud type, which allows the technique to keep up with the drilling at the wellsite.

By accurately accounting for the mineral DRIFTS signature, according to some embodiments, the organic matter signal can be computed by subtracting the mineral signal from the total spectrum. This has significant advantages over known techniques that rely on the kerogen being isolated or the minerals being dissolved in order to get a kerogen signal because such techniques are relatively time consuming and make use of concentrated acids. According to some embodiments, a multi-mineral spectral reconstruction is described that permits complete removal of the mineral signals, thus producing an accurate organic signal. Such embodiments do not rely on multivariate statistics such as partial least squares on a test data set to establish trends with maturity.

DRIFTS, and indeed also transmission FT-IR, respond to the vibrational motions of molecules. In samples containing kerogen, the DRIFTS absorbance comes from minerals and kerogen. Such absorbance is relative, because of the variable nature of the scattering of the infrared energy source. In solving for the mineralogy and kerogen content of these samples, one process is to normalize the abundances of minerals plus kerogen to unity, which effectively quantifies the absorbance from each component. See, e.g. Charsky and Herron, “Quantitative analysis of kerogen content and mineralogy in shale cuttings by Diffuse Reflectance Infrared Fourier Transform Spectroscopy”, International Symposium of the Society of Core Analysts, Scotland, UK, 2012 (hereinafter “Charsky and Herron (2012)”); and United States Patent Publ. No. 2013/0046469 (hereinafter “US 2013/0046469”), both of which are incorporated herein by reference. This produces a quantified kerogen concentration that reflects the underlying C—H bond richness. In the 2800-3000 cm⁻¹ region, this absorbance is due to the aliphatic C—H vibrations. The strength of this vibrational area declines as kerogen matures under the influence of increasing heat and as part of the hydrogen and carbon are released from the kerogen as produced hydrocarbons.

The normalizing technique provides a way to quantify the strength of the signal. The influence of non-kerogen contributors to this portion of the spectrum is also addressed. Charsky and Herron (2012) showed that some carbonate and clay minerals have absorbance bands within the aliphatic 2800-3000 cm⁻¹ region, and this inorganic contribution is removed to produce the normalized organic infrared signal (“kerogen signal”). When combined with a measure of the amount of organic matter, the ratio of the total organic matter concentration to the strength of the kerogen signal (normalized organic infrared signal) is an effective thermal maturity index that closely parallels vitrinite reflectance data.

Maturity indication of kerogen-bearing rocks as opposed to pure kerogen samples, as analyzed by Lis et al., has a number of challenges. A first challenge is the fact that non-organic minerals such as calcite, dolomite, illite, and smectite, among others, contribute to the 2800-3000 and/or 3000-3100 cm⁻¹ region. To remove this interference, according to some embodiments, other portions of the spectrum are used to identify the contributions due to the inorganics and to mathematically remove them from the spectrum leaving the net spectrum due solely to the organic matter.

The reflection spectrum is un-calibrated, as a result of variable light scattering due to the particles involved. According to some embodiments, the reflected spectrum is normalized due to inorganic as well as organic matter to unity, thus providing a means of producing the organic signal quantitatively. An example of this can be found in US 2013/0046469. In this example, an apparent organic matter concentration is computed assuming a standard relationship between the organic matter and the DRIFTS signal. This is the apparent kerogen content, assuming a kerogen factor of 1.

Once the apparent kerogen concentration has been quantified, an external measure of the total organic carbon is added. According to some embodiments, LECO™ or coulometric methods may be used. According to some other embodiments, other laboratory measurements techniques may be used. According to yet other embodiments, the thermal maturity and calibration factor is derived from other parts of the infrared spectrum. According to yet other embodiments, as is described in further detail infra, the total organic carbon is derived from downhole measurements such as a downhole gamma-ray spectroscopy tool.

According to some embodiments, the ratio of total organic carbon to the inorganic free, quantitative DRIFTS signal as a measure of the H/C ratio of the organic matter, and thus a measure of the thermal maturity, is taken.

According to some embodiments, the kerogen that might be present if the thermal maturity corresponds to a vitrinite reflectance around unity is computed from the DRIFTS signal. In this case, the ratio of the total organic carbon to the integrated normalized DRIFTS signal closely follows the vitrinite reflectance.

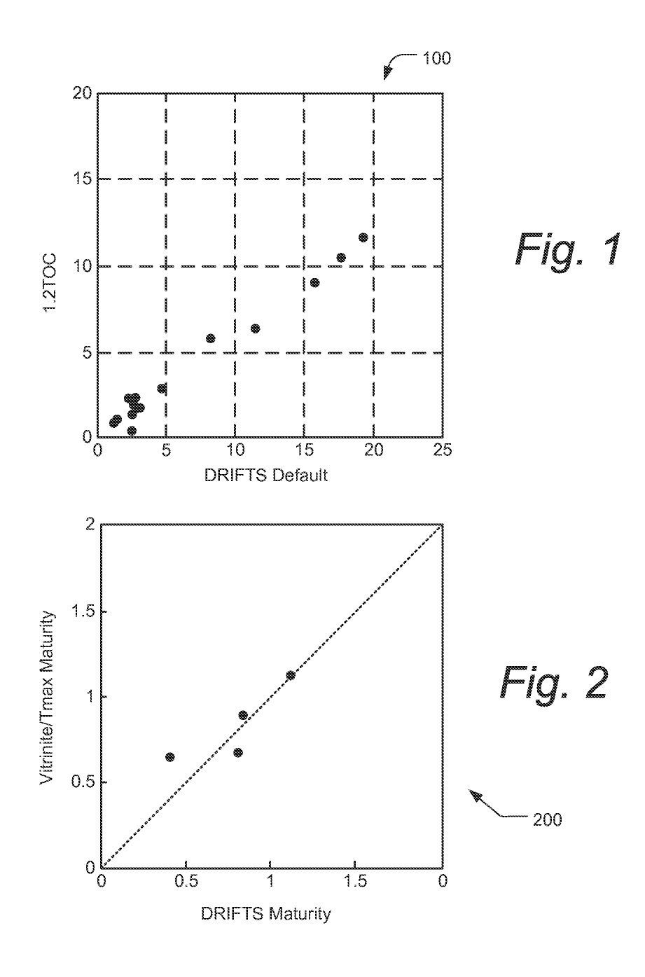

FIG. 1 is a graph illustrating the relationship between the DRIFTS signal and total organic carbon for a set of earth samples, according to some embodiments. On graph 100, each sample is plotted using the DRIFTS kerogen signal, in units designed to equal 1.2 times the total organic carbon (TOC) in sediments at the oil/gas window border, which is about a vitrinite reflectance of 1.0. It can be seen that in this set of samples, taken from a limited depth range, the DRIFTS signal is proportional to 1.2 TOC, but the slope is lower than unity, indicating a less mature environment than the 1.0 standard. The constant slope indicates that samples are of the same thermal maturity as is expected from samples from a limited depth range.

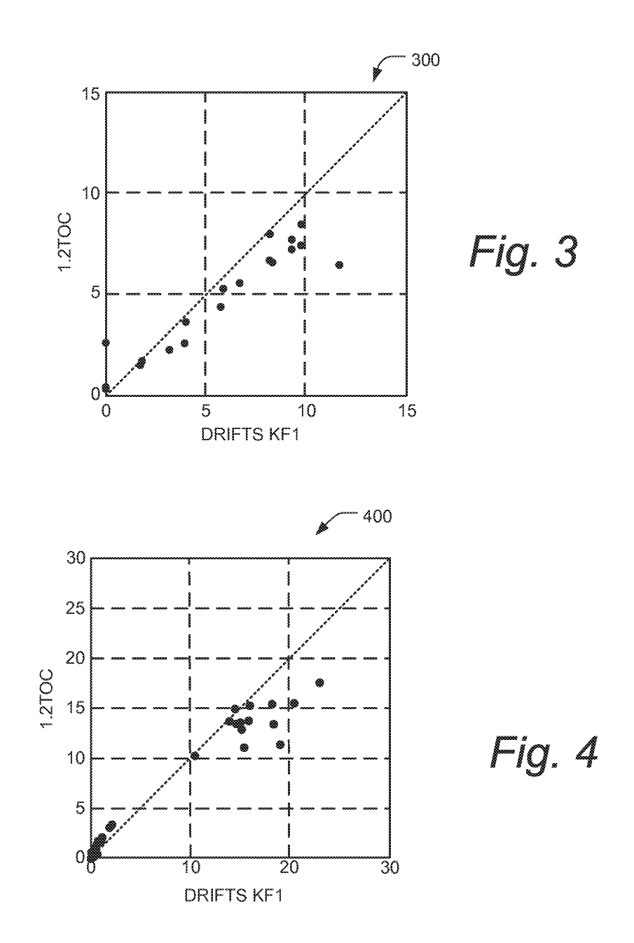

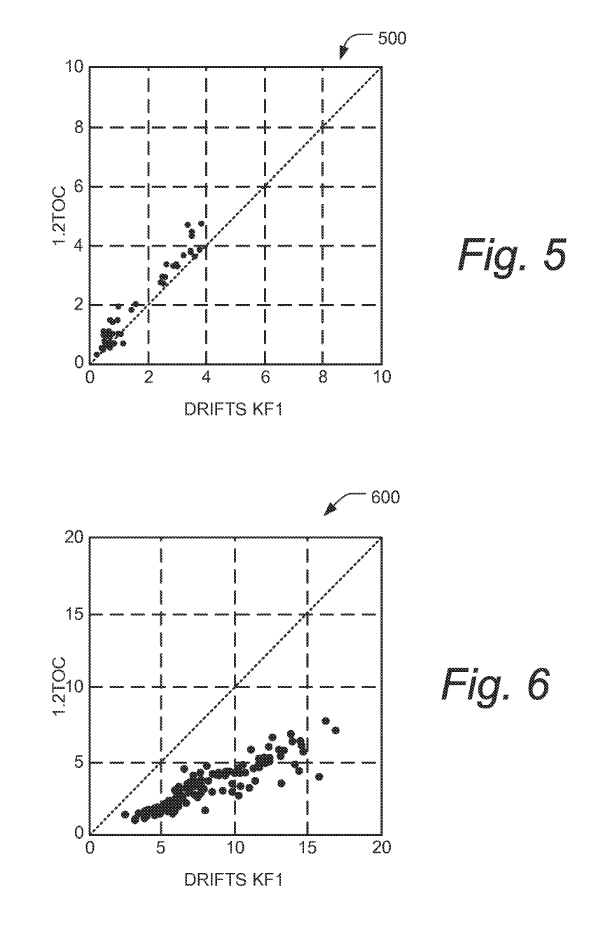

FIG. 2 is a graph comparing measured maturity versus DRIFTS-determined thermal maturity for a number of sample sets, according to some embodiments. Graph 200 plots for each of four sample sets, the actual maturity determined from vitrinite reflectance measurements or computed from Rock-Eval Tₘₐₓ measurements versus the thermal maturity as determined by the slope method of DRIFTS plots such as shown in FIG. 1. In particular, each of the four points plotted in FIG. 2 correspond to the sample sets plotted in FIGS. 3-6, which are described in further detail infra.

FIG. 3 is a graph illustrating the relationship between the kerogen concentration from the DRIFTS signal and total organic carbon for a set of earth samples, according to some embodiments. Graph 300 compares the kerogen concentration from the DRIFTS signal with an assumed kerogen factor of 1, to the actual kerogen content computed as 1.2 times the total organic carbon. In the sample set shown in FIG. 3, the ratio of 1.2 TOC to the DRIFTS signal is approximately 0.8 and the thermal maturity determined from vitrinite reflectance is Rₒ between 0.65 and 0.72.

FIG. 4 is a graph illustrating the relationship between the kerogen concentration from the DRIFTS signal and total organic carbon for a set of earth samples, according to some embodiments. Graph 400 compares the kerogen concentration from the DRIFTS signal with an assumed kerogen factor of 1 to the actual kerogen content computed as 1.2 times the total organic carbon. In the sample set shown in FIG. 4, the ratio of 1.2 TOC to the DRIFTS signal is approximately 0.83 for the organic-rich samples and the thermal maturity determined from Rock-Eval Tₘₐₓ of about 460° F. corresponds to a computed vitrinite reflectance of about 0.9.

FIG. 5 is a graph illustrating the relationship between the kerogen concentration from the DRIFTS signal and total organic carbon for a set of earth samples, according to some embodiments. Graph 500 compares the kerogen computed from the DRIFTS signal with an assumed kerogen factor of 1, to the actual kerogen content computed as 1.2 times the total organic carbon. In the sample set shown in FIG. 5, the ratio of 1.2 TOC to the DRIFTS signal is approximately 1.11 for the organic-rich samples and the thermal maturity determined from Rock-Eval Tₘₐₓ corresponds to a computed vitrinite reflectance of about 1.13. Note that the example set shown in FIG. 5 indicates a thermal maturity greater than unity.

FIG. 6 is a graph illustrating the relationship between the kerogen concentration from the DRIFTS signal and total organic carbon for a set of earth samples, according to some embodiments. Graph 600 compares the kerogen concentration computed from the DRIFTS signal with an assumed kerogen factor of 1, to the actual kerogen content computed as 1.2 times the total organic carbon. The ratio of 1.2 TOC to the DRIFTS signal as shown in FIG. 5 is approximately 0.4 for the organic-rich samples and the thermal maturity determined from Rock-Eval Tₘₐₓ corresponds to a computed vitrinite reflectance of about 0.65.

According to some embodiments, it has been found that the described techniques are particularly applicable to hydrogen-rich kerogens, Types I and II, which generally include the major shale gas and shale oil deposits. According to some embodiments, Type III kerogens, which produce some gas and then coal, are hydrogen-poor, and use a separate calibration of the DRIFTS signal.

Thus, according to some embodiments, the DRIFTS thermal maturity measure is determined from the slope of 1.2 times TOC versus the nominal DRIFTS organic signal for each point. Slopes have uncertainties, particularly at low organic concentrations as can be seen in plots 300, 400, 500 and 600 in the FIGS. 3-6, respectively. Therefore, according to some embodiments an estimation of thermal maturity from DRIFTS and TOC is enhanced when made on several samples and from organic-rich samples. In general, it has been found that it is not necessary to measure TOC on every sample from a well where DRIFTS is determined. According to some embodiments, once a reliable thermal maturity index is determined from multiple DRIFTS and TOC measurements, further TOC values can be determined directly from the DRIFTS measurements and the known thermal maturity index.

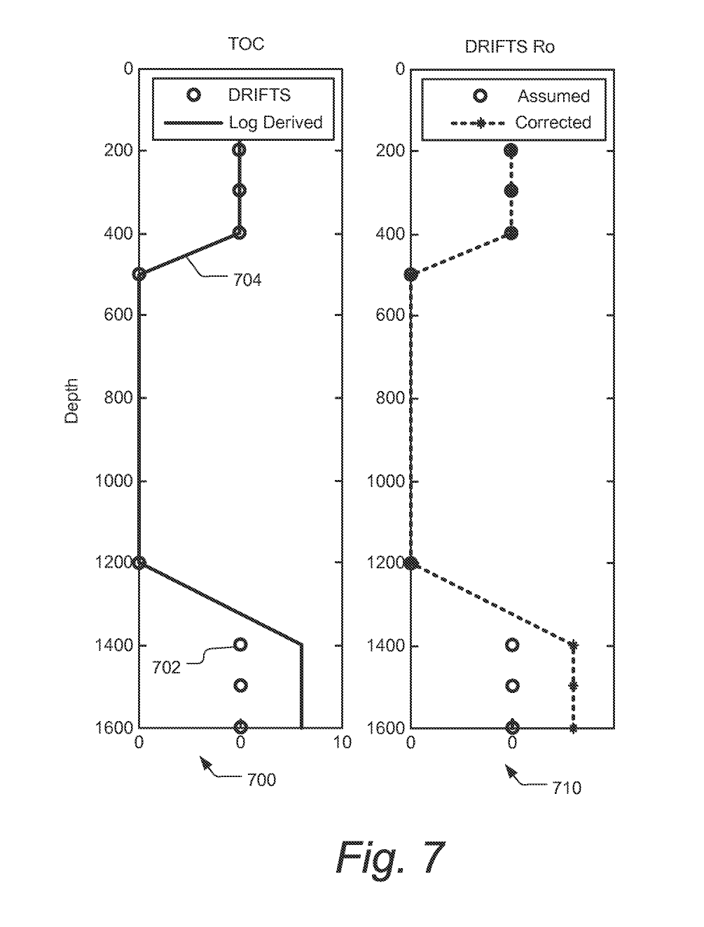

FIG. 7 shows two graphs illustrating aspects of borehole log derived total organic carbon and DRIFTS data, according to some embodiments. The left graph 700 shows DRIFTS data markers 702 and Log Derived TOC 704. As can be seen, the DRIFTS and Log Derived TOC are equivalent in upper depths. However, the Log Derived TOC 704 is higher at greater depths, indicating that the DRIFTS kerogen factor is too low. In graph 710, the kerogen factor has been adjusted to honor the Log Derived TOC, thus producing higher values of DRIFTS Rₒ. According to some embodiments, a high-definition gamma-ray spectroscopy wireline borehole tool such as Schlumberger's Litho Scanner tool is used to independently derive the TOC. According to other embodiments, other types of wireline or other borehole monitoring tools, including LWD tools, can be used to generate an independent TOC value, if available.

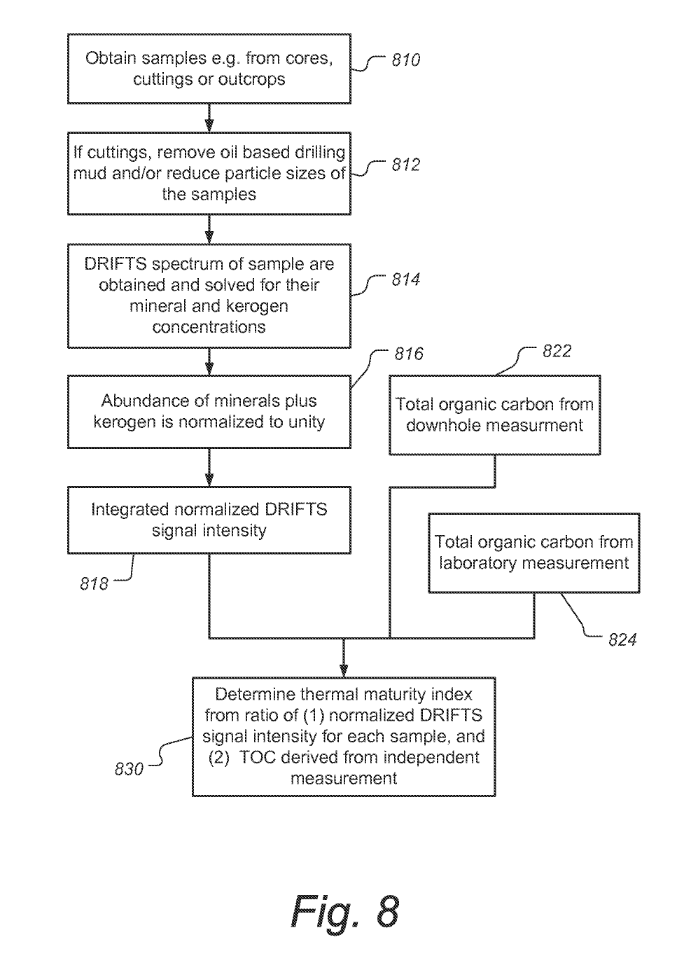

FIG. 8 is a flow chart illustrating aspects of determining thermal maturity of a rock formation based on DRIFTS analysis, according to some embodiments. In block 810 samples of the rock formation are obtained. According to some embodiments, the samples are taken from core samples, cleaned well cuttings and/or outcrop samples. In block 812, if the samples are taken from cuttings from a drilling process that uses oil-based-mud, the oil is removed. If the particle size is larger than suitable for the DRIFTS process, the particle size is reduced. In block 814, for each sample, a DRIFTS spectrum is obtained and solved for their mineral and kerogen concentrations. In block 816, for each sample, the abundance of minerals plus kerogen is normalized to unity. The normalizing technique provides a way to quantify the strength of this signal. In blocks 822 and/or 824, an external measurement of the amount of organic carbon is obtained. In block 822, a downhole measurement is used. According to some embodiments, a gamma-ray tool is used such as described with respect to FIG. 7, supra. In block 824, a laboratory method is used such as a LECO™ or coulometric measurement. According to some other embodiments, the total organic carbon is derived from other parts of the infrared spectrum. Finally, in block 830 the ratio of the total organic carbon concentration to the concentration of organic matter from the normalized infrared signal is used to determine a measure of thermal maturity. According to some embodiments, for each sample is plotted according to 1.2 times TOC on one axis and the nominal DRIFTS organic signal on the other axis. The DRIFTS derived thermal maturity (DRo) is equal to the slope of a line indicated by the plotted data points. According to some embodiments, several organic-rich samples from the same well are used to determine DRo so that the slope can be determined with greater accuracy.

According to some embodiments the relationship between the DRo, the normalized DRIFTS signal and the TOC as described herein is used to determine TOC in cases where thermal maturity information is available for the given rock formation. In many cases, organic thermal maturity is known for a given field. In such cases the DRIFTS analysis techniques described herein can be combined with the known thermal maturity information for determine total organic carbon, which can be used, for example to define reservoir quality in unconventional reservoirs. Such techniques can be useful, for example, in reducing or eliminating reliance on a local core analysis for determining TOC.

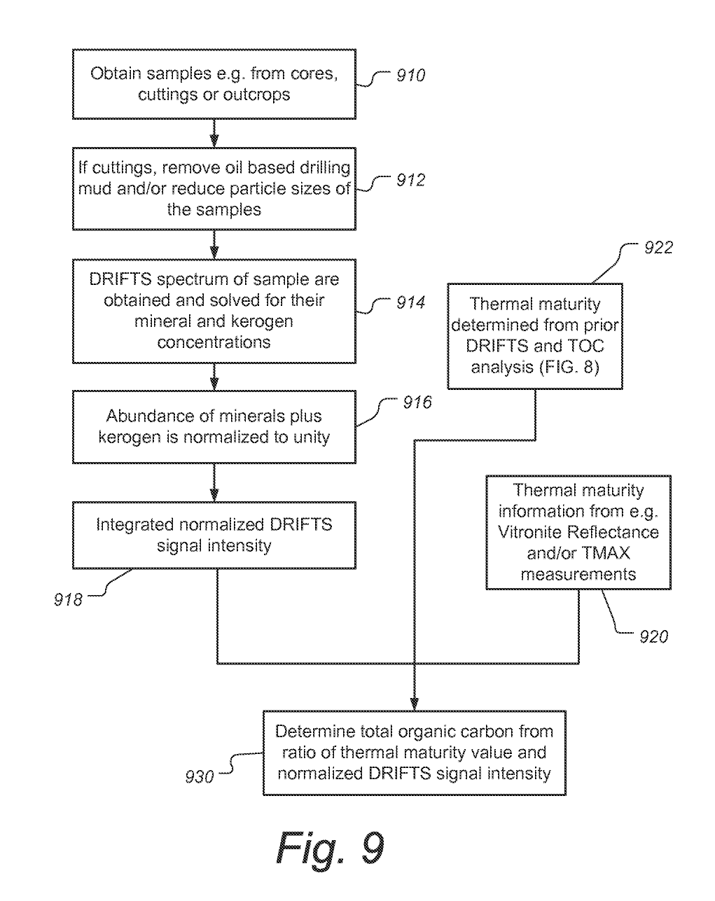

FIG. 9 is a flow chart illustrating aspects of determining TOC of a rock formation based on DRIFTS analysis, according to some embodiments. In block 910 samples of the rock formation are obtained. According to some embodiments, the samples are taken from core samples, cleaned well cuttings and/or outcrop samples. In block 912, if the samples are taken from cuttings from a drilling process that uses oil-based-mud, the oil is removed. If the particle size is larger than suitable for the DRIFTS process, the particle size is reduced. In block 914, for each sample, a DRIFTS spectrum is obtained and solved for their mineral and kerogen concentrations. In block 916, for each sample, the abundance of minerals plus kerogen is normalized to unity. The normalizing technique provides a way to quantify the strength of this signal. In block 920, information about thermal maturity of the rock formation is obtained. Examples of known techniques that can be used include vitronite reflectance measurements and/or RockEval, which gives the temperature of maximum organic emission (Tₘₐₓ) that is a proxy for thermal maturity. In many cases the vitronite reflectance and/or Tₘₐₓ data will have already been collected. In block 930 the relationship (e.g. ratio) between normalized thermal maturity and the concentration of organic matter from the normalized infrared signal is used to determine the TOC.

According to some embodiments, in block 922, thermal maturity is known from measurements of DRIFTs and TOC on prior earth samples (e.g. from the same or close depth interval of the same well and/or the same rock formation in a different well/location), according to the process shown in FIG. 8. An example of such embodiments includes using several samples from a depth interval to determine the thermal maturity index such as shown in FIG. 8. Once the maturity index is known, then for further samples from the same formation, the process of FIG. 9 is used to determine the TOC directly from the DRIFTS measurements.

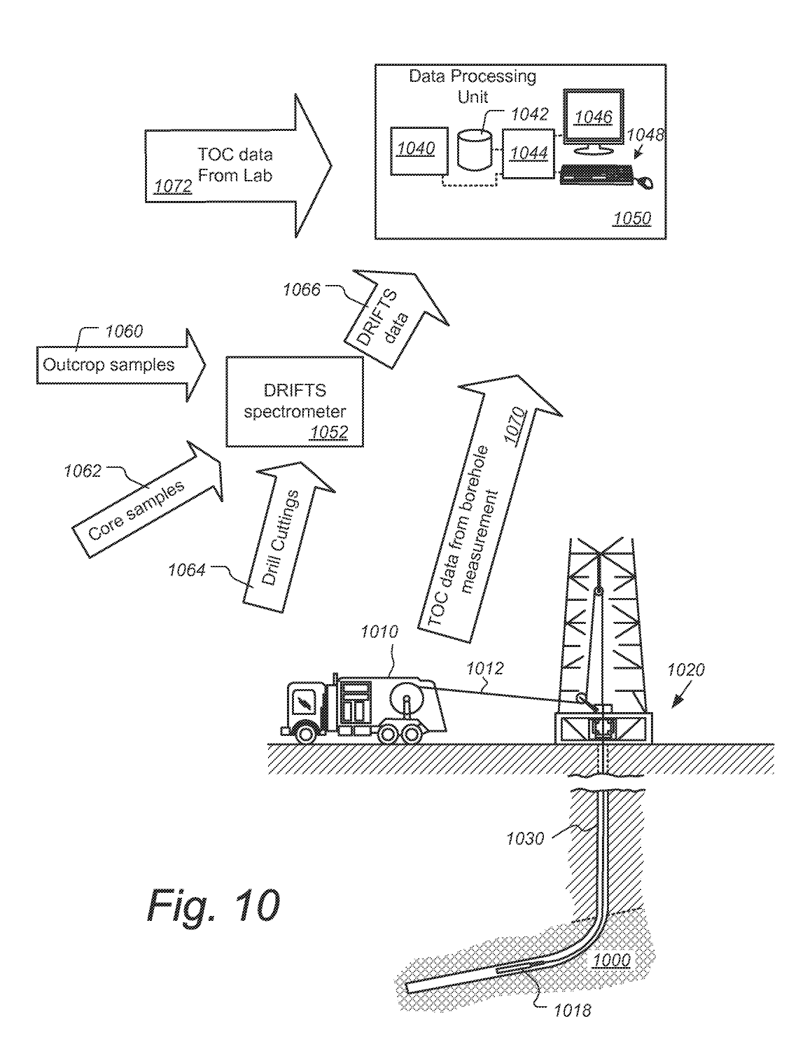

FIG. 10 is a diagram showing a wireline tool being deployed in a wellbore along with a DRIFTS spectrometer and processing unit for determining thermal maturity, according to some embodiments. Wireline truck 1010 is deploying wireline cable 1012 into well 1030 via wellsite 1020. Wireline tool 1018 is disposed on the end of the cable 1012 in a subterranean rock formation 1000. According to some embodiments, formation 1000 is an unconventional reservoir, such as shale gas and shale oil deposits. Tool 1018, according to some embodiments is a gamma-ray tool capable of making measurements from which total organic carbon (TOC) can be determined. According to some embodiments, tool 1018 is a Litho Scanner tool from Schlumberger. According to some embodiments, other wireline tools can also be included on the tool string at the end of wireline cable 1012. Data from the tool 1018 from rock formation 1000 are retrieved at the surface in logging truck 1010. From the downhole measurements, the TOC data 1070 is generated from which TOC can be determined.

According to some embodiments, the TOC is determined processing facility 1050, which can be located in the logging truck 1010 or at some other location at wellsite 1020. According to some embodiments, data processing unit 1050 is located at one or more locations remote from the wellsite 1020. The processing unit 1050 includes one or more central processing units 1044, storage system 1042, communications and input/output modules 1040, a user display 1046 and a user input system 1048.

According to some embodiments, a DRIFTS spectrometer 1052 receives samples of reservoir rock 1000 in a form such as outcrop samples 1060, core samples 1062 and/or drill cuttings 1064. After sample preparation (e.g. washing and/or particle size modification) the DRIFTS spectrometer generates DRIFTS sample data 1066 that is processed and interpreted in processing unit 1050. According to some embodiments, TOC data 1072 is received from a lab facility instead of or in addition to TOC data 1070 from borehole measurements. Processing unit 1050 carries out the processing steps such as described in FIG. 8 and generates the measure of thermal maturity such as described in FIG. 8 According to some embodiments, in cases where thermal maturity information for reservoir rock 1000 is already known, processing unit carries out processing steps described in FIG. 9 and determines the TOC value, instead of receiving the TOC data 1070 and/or 1072.

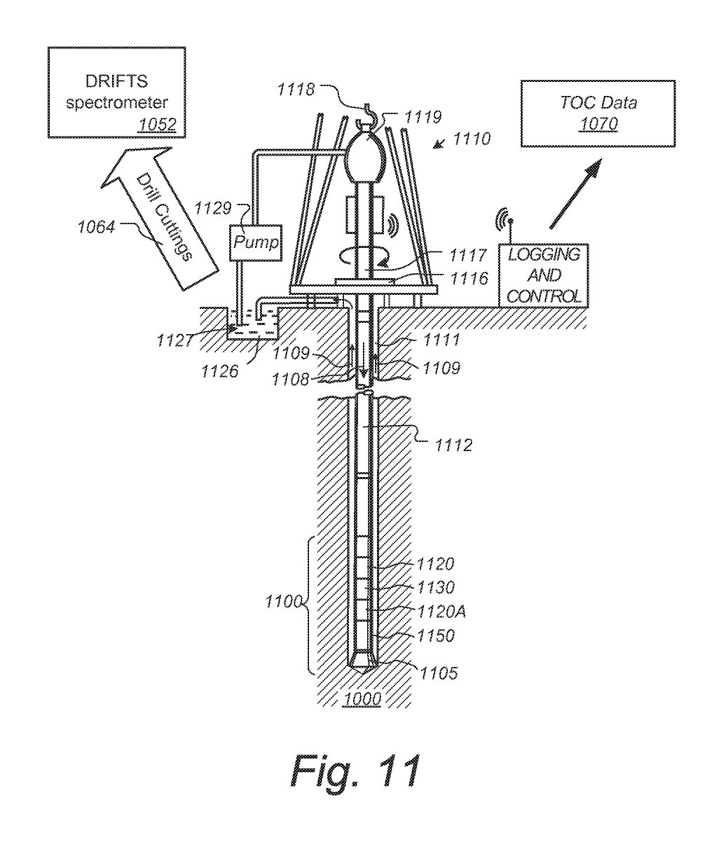

FIG. 11 illustrates a wellsite system in which a thermal maturity value can be determined from DRIFTS analysis of drill cuttings while drilling, according to some embodiments. The wellsite can be onshore or offshore. In this system, a borehole 1111 is formed in subsurface formations by rotary drilling in a manner that is well known. Embodiments can also use directional drilling, as will be described hereinafter.

A drill string 1112 is suspended within the borehole 1111 and has a bottom hole assembly 1100 that includes a drill bit 1105 at its lower end. The surface system includes platform and derrick assembly 1110 positioned over the borehole 1111, the assembly 1110 including a rotary table 1116, kelly 1117, hook 1118 and rotary swivel 1119. The drill string 1112 is rotated by the rotary table 1116, energized by means not shown, which engages the kelly 1117 at the upper end of the drill string. The drill string 1112 is suspended from a hook 1118, attached to a traveling block (also not shown), through the kelly 1117 and a rotary swivel 1119, which permits rotation of the drill string relative to the hook. As is well known, a top drive system could alternatively be used.

In the example of this embodiment, the surface system further includes drilling fluid or mud 1126, stored in a pit 1127 formed at the well site. A pump 1129 delivers the drilling fluid 1126 to the interior of the drill string 1112 via a port in the swivel 1119, causing the drilling fluid to flow downwardly through the drill string 1112, as indicated by the directional arrow 1108. The drilling fluid exits the drill string 1112 via ports in the drill bit 1105, and then circulates upwardly through the annulus region between the outside of the drill string and the wall of the borehole, as indicated by the directional arrows 1109. In this well-known manner, the drilling fluid lubricates the drill bit 1105 and carries formation cuttings up to the surface as it is returned to the pit 1127 for recirculation.

The bottom hole assembly 1100 of the illustrated embodiment contains a logging-while-drilling (LWD) module 1120, a measuring-while-drilling (MWD) module 1130, a roto-steerable system and motor, and drill bit 1105.

The LWD module 1120 is housed in a special type of drill collar, as is known in the art, and can contain one or a plurality of known types of logging tools. It will also be understood that more than one LWD and/or MWD module can be employed, e.g. as represented at 1120A. (References throughout, to a module at the position of 1120, can alternatively mean a module at the position of 1120A as well.) The LWD module includes capabilities for measuring, processing, and storing information, as well as for communicating with the surface equipment. In the present embodiment, the LWD module includes a resistivity measuring device as well as a number of other devices, such as a neutron-density measuring device.

The MWD module 1130 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

According to some embodiments, drill cuttings 1064 are taken from the drilling mud, cleaned and analyzed using DRIFTS spectrometer 1052. The data from the DRIFTS spectrometer 1052 is processed by a processing unit, such as shown in FIG. 10. According to some embodiments, if available, LWD module 1120 includes a tool such as a gamma-ray tool that can provide data 1070 from which TOC can be derived. According to some embodiments, analysis as shown in FIG. 8 is carried out while drilling.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A method of analyzing earth samples comprising:
analyzing a first sample using diffuse reflectance infrared fourier transform spectroscopy (DRIFTS) to collect one or more spectra of infrared energy reflected from the first earth sample and to create a first spectral dataset therefrom;
analyzing the first spectral dataset thereby generating a first processed DRIFTS signal;
receiving total organic matter data representing a concentration of organic material in the first earth sample; and
determining a thermal maturity value indicative of a thermal maturation history of the first earth sample, said determining based at least in part on the first processed DRIFTS signal and the total organic matter data.

2. A method according to claim 1 wherein said analyzing the first spectral dataset comprises removing influence of inorganic materials from the first spectral dataset and normalizing the first spectral dataset to generate a first normalized organic infrared signal.

3. A method according to claim 2 wherein said determining a thermal maturity value is further based on a ratio of the first total organic matter data and the first normalized organic infrared signal.

4. A method according to claim 2 wherein the first processed DRIFTS signal is based on reflected spectra of the infrared energy in a region having a range of between 2800-3100 cm⁻¹, and said removing is based at least in part on using one or more spectra outside of said region to identify contributions due to the inorganic materials.

5. A method according to claim 2 wherein the normalizing includes computing an apparent organic matter concentration assuming a standard relationship between organic matter and the first processed DRIFTS signal.

6. A method according to claim 1 further comprising:
analyzing a second sample using DRIFTS to collect one or more spectra of infrared energy reflected from the second earth sample and to create a second spectral dataset therefrom;
analyzing the second spectral dataset thereby generating a second processed DRIFTS signal, wherein said determining a thermal maturity value is further based at least in part on the second processed DRIFTS signal.

7-11. (canceled)

12. A method according to claim 1 wherein said method is performed at a wellsite.

13. A method according to claim 12 wherein said method is performed during a drilling process and said earth samples are gathered from drill cuttings.

14. A system for analyzing earth samples comprising:
a diffuse reflectance infrared fourier transform spectroscopy (DRIFTS) system configured to collect one or more spectra of the infrared energy reflected from the earth samples; and
a processing system configured to receive data representing spectra collected by the DRIFTS system and data representing total organic matter of the earth samples, and to determine a thermal maturity value indicative of a thermal maturation history of the earth samples, said thermal maturity value being based at least in part on the received data representing spectra and the received data representing total organic matter.

15. A system according to claim 14 wherein the processing system is further configured to remove influence of inorganic materials from the data representing spectra and normalize the data representing spectra to generate a normalized organic infrared signal.

16. A system according to claim 15 wherein said a thermal maturity value is further based on a ratio of the data representing total organic matter and the normalized organic infrared signal.

17. A system according to claim 14 further comprises a downhole gamma-ray measurement tool and wherein the data representing total organic matter indicates total organic carbon and is based on one or more downhole measurements made by the tool.

18. A system according to claim 14 wherein said system is configured for deployment at a wellsite and said earth samples are gathered from drill cuttings.

19. A method of analyzing an earth sample comprising:
analyzing a first sample using diffuse reflectance infrared fourier transform spectroscopy (DRIFTS) to collect one or more spectra of infrared energy reflected from the first earth sample and to create a spectral dataset therefrom;
analyzing the spectral dataset thereby generating a processed DRIFTS signal;
receiving thermal maturity data indicative of a thermal maturation history of the first earth sample; and
determining a TOC value representing a concentration of organic material in the first earth sample based at least in part on a relationship between the processed DRIFTS signal intensity and the thermal maturity data.

20. A method according to claim 19 wherein said analyzing the spectral dataset comprises removing influence of inorganic materials from the processed DRIFTS signal and normalizing the processed DRIFTS signal to generate a first normalized organic infrared signal.

21. A method according to claim 19 further comprising repeating said analyzing and determining, for further earth samples to create further spectral datasets and further TOC values based on said further spectral datasets.

22. A method according to claim 19 wherein the thermal maturity data is based on vitronite reflectance measurements.

23. A method according to claim 19 wherein the thermal maturity data is based on Tₘₐₓ measurements.

24. A method according to claim 19 wherein the thermal maturity data is determined from DRIFTS and TOC measurements performed on other earth samples taken from a same rock formation as said earth samples.

25-30. (canceled)
